(19) United States
(12) Patent Application Publication
(10) Pub. No.: US 2019/0129458 A1
(43) Pub. Date: May 2, 2019

(54) LOW DROPOUT LINEAR REGULATOR WITH HIGH POWER SUPPLY REJECTION RATIO

(71) Applicant: Hangzhou Hongxin Microelectronics Technology Co., Ltd., Hangzhou (CN)

(72) Inventor: Chih-yang WANG, Hangzhou (CN)

(73) Assignee: Hangzhou Hongxin Microelectronics Technology Co., Ltd., Hangzhou (CN)

(21) Appl. No.: 15/871,966

(22) Filed: Jan. 15, 2018

(30) Foreign Application Priority Data
Oct. 30, 2017 (CN) 201711037092.0

(51) Int. Cl. G05F 1/595

(52) U.S. Cl. CPC G05F 1/595

(57) ABSTRACT

The present invention provide a low dropout linear regulator with high power supply rejection ratio, including: a voltage dividing unit for generating a voltage dividing signal; a comparison unit including two input ends and an output end, one of the two input ends coupled with the voltage dividing unit for receiving the voltage dividing signal, the other input end for receiving a reference voltage signal, and the output end for outputting an amplified voltage signal according to the voltage dividing signal and the reference voltage signal; a voltage amplifying unit coupled with an output end of the comparison unit for providing a switch signal; and the switch unit coupled with the output end of the comparison unit, the voltage dividing unit and the voltage amplifying unit for responding to the switch signal and receiving and outputting a voltage reduction signal according to the amplified voltage signal.

### CROSS-REFERENCE TO RELATED APPLICATIONS

This Non-provisional application claims priority under 35 U.S.C. § 119(a) on Patent Application No(s). 201711037092.0 filed in People's Republic of China on Oct. 30, 2017, the entire contents of which are hereby incorporated by reference.

### BACKGROUND OF THE INVENTION

### Field of the Invention

The present invention relates to a technical field of low dropout linear regulator apparatus and, more particularly, to a low dropout linear regulator with high power supply rejection ratio.

### Description of the Related Art

A low dropout regulator (LDO) is a low dropout linear regulator. As shown in FIG. 1, the existing low dropout linear regulator generally consists of a positive channel metal oxide semiconductor (PMOS) switch tube, voltage divider resistors R1 and R2, and a comparison amplifier. The principle is: a divided voltage is coupled with one input end of the comparison amplifier and is compared with a reference voltage added to the other input end, and the difference of the two is amplified by the comparison amplifier to control the voltage drop of the PMOS switch tube, so as to stabilize an output voltage. To improve the product performance, people tend to study in the direction of reducing the output noise. However, when the frequency of the present circuit is 10 Mega Hz, the outputted noise becomes larger than the inputted power supply noise, and the reason mainly lies in three aspects: the first one is due to the PMOS tube having a parasitic coupling capacitor therein, the output of VOUT is affected by the coupling capacitor; the second one is due to the comparison amplifier also having a coupling capacitor therein, the voltage of VA is affected by the coupling capacitor and cannot follow VDD, as a result of which ν_{gs} (VDD−VA) of the PMOS jitters with VDD constantly; and the third one is that the noise affects VA through VVD and also affects VOUT.

### BRIEF SUMMARY OF THE INVENTION

The present invention provides a low dropout linear regulator with high power supply rejection ratio to solve the above-mentioned problems.

To solve the above-mentioned problems, one embodiment of the present invention provides a low dropout linear regulator with high power supply rejection ratio, including a voltage dividing unit, a comparison unit, a voltage amplifying unit, and a switch unit;

the voltage dividing unit, configured to generate a voltage dividing signal;

the comparison unit, including two input ends and an output end, wherein one of the two input ends is coupled with the voltage dividing unit for receiving the voltage dividing signal, the other input end is configured to receive a reference voltage signal, and the output end is configured to output an amplified voltage signal according to the voltage dividing signal and the reference voltage signal;

the voltage amplifying unit, coupled with an output end of the comparison unit for providing a switch signal; and

the switch unit, coupled with the output end of the comparison unit, the voltage dividing unit, and the voltage amplifying unit for responding to the switch signal and receiving and outputting a voltage reduction signal according to the amplified voltage signal, the switch unit includes a first n-metal-oxide-semiconductor (NMOS) transistor, a gate of the first NMOS transistor may be coupled with the output end of the comparison unit, a drain may be coupled with a first voltage signal, and a source may be coupled with the voltage dividing unit.

As an implementation mode, the low dropout linear regulator with high power supply rejection ratio may further include a noise reduction unit. The noise reduction unit may include a second NMOS transistor. A gate and a drain of the second NMOS transistor may be both coupled with the first voltage signal, and a source may be coupled with the drain of the first NMOS transistor.

As an implementation mode, the noise reduction unit may further include a first resistor. One end of the first resistor may be coupled with the gate of the second NMOS transistor, and the other end may be coupled with the first voltage signal.

As an implementation mode, the low dropout linear regulator with high power supply rejection ratio may further include a filter unit. The filter unit may include the first resistor and a second capacitor. One end of the first resistor may be coupled with the gate of the second NMOS transistor, the other end may be coupled with the first voltage signal, and the second capacitor may be coupled with a connection node of the first resistor and the second NMOS transistor.

As an implementation mode, the first NMOS transistor and the second NMOS transistor may adopt a native n-channel metal-oxide-semiconductor field-effect transistor (NFET) to get a better headroom.

As an implementation mode, the voltage amplifying unit may include a first capacitor. One end of the first capacitor may be coupled with a connection node of the comparison unit and the switch unit, and the other end may be grounded.

Compared with the prior art, the present invention has the following beneficial effects: through the voltage amplifying unit and the first NMOS transistor, a high power supply rejection ratio can be provided, a stable voltage reduction signal can be outputted, the noise output can be reduced, and the output signal of the comparison unit can follow the first voltage signal; by disposing the second NMOS transistor between the first NMOS transistor and the first voltage signal, the current generated by the first voltage signal can be directly avoided from flowing from the drain of the first NMOS transistor to the source.

### BRIEF DESCRIPTION OF THE DRAWINGS

FIG. 1 is a circuit diagram of a low dropout linear regulator of the prior art; and

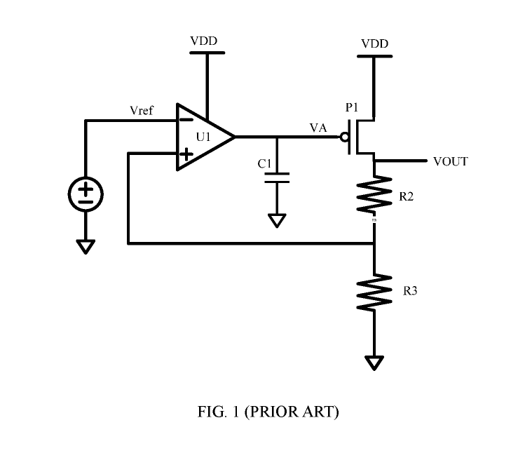

FIG. 2 is a circuit diagram of the low dropout linear regulator with high power supply rejection ratio of the present invention.

Figure reference numbers: 1 voltage dividing unit; 2 comparison unit; 3 voltage amplifying unit; 4 switch unit; 5 noise reduction unit.

### DETAILED DESCRIPTION OF THE INVENTION

The above and other technical features and advantages of the present invention will be clearly and completely described combining with the accompanying drawings hereinafter. Apparently, the described embodiments are merely parts of the embodiments of the present invention instead of all the embodiments.

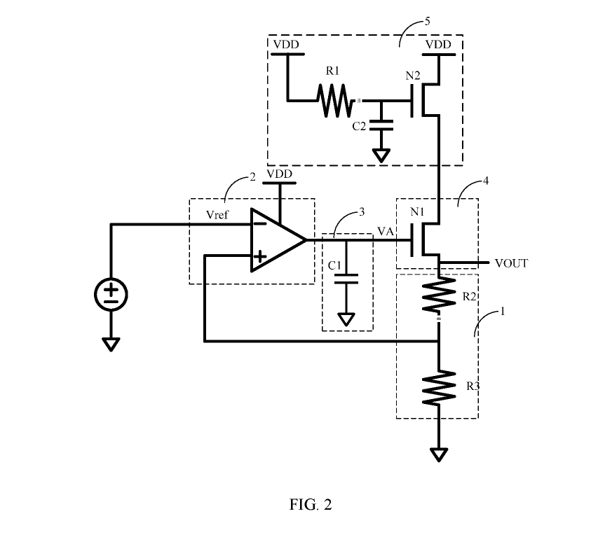

As shown in FIG. 2, a low dropout linear regulator with high power supply rejection ratio, includes a voltage dividing unit 1, a comparison unit 2, a voltage amplifying unit 3 and a switch unit 4; the voltage dividing unit 1 is configured to a voltage dividing signal; the comparison unit 2 includes two input ends and an output end, wherein one of the two input ends is coupled with the voltage dividing unit 1 for receiving the voltage dividing signal, the other input end is configured to receive a reference voltage signal V_{ref}, and the output end is configured to output an amplified voltage signal according to the voltage dividing signal and the reference voltage signal; the voltage amplifying unit 3 is coupled with an output end of the comparison unit 2 for providing a switch signal; and the switch unit 4 is coupled with the output end of the comparison unit 2, the voltage dividing unit 1, and the voltage amplifying unit 3 for responding to the switch signal and receiving and outputting a voltage reduction signal VOUT according to the amplified voltage signal, the switch unit 4 includes a first n-metal-oxide-semiconductor (NMOS) transistor, a gate of the first NMOS transistor is coupled with the output end of the comparison unit 2, a drain is coupled with a first voltage signal VDD, and a source is coupled with the voltage dividing unit 1.

The voltage amplifying unit 3 includes a first capacitor. One end of the first capacitor is coupled with a connection node of the comparison unit 2 and the switch unit 4, and the other end is grounded. The actual solution is to add a capacitor in the original circuit. In the present embodiment, the first capacitor is a capacitor with large capacity (that is, a superposition of an existing capacitor and the voltage amplifying unit 3) for providing the switch signal to the first NMOS transistor to turn on the first NMOS transistor.

In one embodiment, in order to prevent the current generated by the first voltage signal from flowing directly from the drain of the first NMOS transistor to the source, the low dropout linear regulator with high power supply rejection ratio of the present invention further includes a noise reduction unit 5. The noise reduction unit 5 includes a second NMOS transistor. A gate and a drain of the second NMOS transistor are both coupled with the first voltage signal, and a source is coupled with the drain of the first NMOS transistor. In the present embodiment, the first NMOS transistor and the second NMOS transistor both adopt a native n-channel metal-oxide-semiconductor field-effect transistor (NFET).

In one embodiment, in order to increase the bandwidth of the second NMOS transistor, the noise reduction unit 5 of the low dropout linear regulator with high power supply rejection ratio of the present invention further includes a first resistor R1. One end of the first resistor R1 is coupled with the gate of the second NMOS transistor, and the other end is coupled with the first voltage signal VDD. In the circuit composed of the first resistor R1 and the second NMOS transistor, the first resistor R1 plays a role of an active inductor, which can increase the bandwidth of the circuit composed of the first resistor R1 and the second NMOS transistor, so as to increase the output of the low dropout linear regulator.

In another embodiment, in order to provide a stable operating point for the first NMOS transistor, a filter unit is disposed at the input end of the second NMOS transistor. The filter unit includes the first resistor R1 and a second capacitor C2. One end of the first resistor R1 is coupled with the gate of the second NMOS transistor, the other end is coupled with the first voltage signal VDD, and the second capacitor C2 is coupled with a connection node of the first resistor R1 and the second NMOS transistor.

The drain current calculation formula when the switch is saturated is

$$I = \frac{1}{2} {μ}_{N} {cox ( {v}_{gs} - {v}_{th} )}^{2} \frac{W}{L} ,$$

wherein, μ_{N} is the electron transfer rate, cox is the gate oxide layer capacitance per unit area,

$$\frac{W}{L}$$

is the aspect ratio, and ν_{gs}−νₜₕ is the overdrive voltage. In the present embodiment, ν_{gs} is the voltage difference between the gate voltage of the first NMOS transistor and the output voltage (that is, voltage reduction signal). Therefore, compared to the existing solution using a PMOS, the voltage difference of the present invention will be more stable. What's more, the present invention does not require a large return circuit to supplement the capacitance, the chip area is significantly reduced, and the number of the components externally connected with the chip is reduced. Therefore, the low dropout linear regulator of the present invention can provide a high power supply rejection ratio, output a stable voltage reduction signal, reduce the noise output, and make the output signal of the comparison unit 2 follow the first voltage signal.

In the present invention, through the voltage amplifying unit 3 and the first NMOS transistor, a high power supply rejection ratio can be provided, a stable voltage reduction signal can be outputted, the noise output can be reduced, and the output signal of the comparison unit 2 can follow the first voltage signal; by disposing the second NMOS transistor between the first NMOS transistor and the first voltage signal, the current generated by the first voltage signal can be directly avoided from flowing from the drain of the first NMOS transistor to the source.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

1. A low dropout linear regulator with high power supply rejection ratio, comprising a voltage dividing unit, a comparison unit, a voltage amplifying unit, and a switch unit;
the voltage dividing unit, configured to generate a voltage dividing signal;
the comparison unit, comprising two input ends and an output end, one of the two input ends being coupled with the voltage dividing unit for receiving the voltage dividing signal, the other input end configured to receive a reference voltage signal, and the output end configured to output an amplified voltage signal according to the voltage dividing signal and the reference voltage signal;
the voltage amplifying unit, coupled with the output end of the comparison unit for providing a switch signal; and
the switch unit, coupled with the output end of the comparison unit, the voltage dividing unit, and the voltage amplifying unit for responding to the switch signal and receiving and outputting a voltage reduction signal according to the amplified voltage signal, wherein the switch unit comprises a first n-metal-oxide-semiconductor (NMOS) transistor, a gate of the first NMOS transistor is coupled with the output end of the comparison unit, a drain is coupled with a first voltage signal, and a source is coupled with the voltage dividing unit.

2. According to the low dropout linear regulator with high power supply rejection ratio of claim 1, further comprising a noise reduction unit, wherein the noise reduction unit comprises a second NMOS transistor, a gate and a drain of the second NMOS transistor are both coupled with the first voltage signal, and a source is coupled with the drain of the first NMOS transistor.

3. According to the low dropout linear regulator with high power supply rejection ratio of claim 2, wherein the noise reduction unit further comprises a first resistor, one end of the first resistor is coupled with the gate of the second NMOS transistor, and the other end is coupled with the first voltage signal.

4. According to the low dropout linear regulator with high power supply rejection ratio of claim 2, further comprising a filter unit, wherein the filter unit comprises a first resistor and a second capacitor, one end of the first resistor is coupled with the gate of the second NMOS transistor, the other end is coupled with the first voltage signal, and the second capacitor is coupled with a connection node of the first resistor and the second NMOS transistor.

5. According to the low dropout linear regulator with high power supply rejection ratio of claim 1, wherein the first NMOS transistor and the second NMOS transistor adopt a native n-channel metal-oxide-semiconductor field-effect transistor (NFET).

6. According to the low dropout linear regulator with high power supply rejection ratio of claim 1, wherein the voltage amplifying unit comprises a first capacitor, one end of the first capacitor is coupled with a connection node of the comparison unit and the switch unit, and the other end is grounded.
